(19) United States
(12) Patent Application Publication
(10) Pub. No.: US 2017/0274688 A1
(43) Pub. Date: Sep. 28, 2017

(54) MEDIUM FEEDING APPARATUS AND CONTROL METHOD OF MEDIUM FEEDING APPARATUS

(71) Applicant: SEIKO EPSON CORPORATION, Tokyo (JP)

(72) Inventors: Kenji HATADA, Shiojiri-Shi (JP); Takao YAMAMOTO, Shiojiri-shi (JP); Hidenobu OTA, Hara-mura (JP); Kazuma OZAKI, Okaya-shi (JP)

(21) Appl. No.: 15/460,410

(22) Filed: Mar. 16, 2017

(30) Foreign Application Priority Data
Mar. 23, 2016 (JP) 2016-059150

(51) Int. Cl. B41J 29/38; B41J 15/04; B41J 2/01; B41J 15/02

(52) U.S. Cl. CPC B41J 29/38; B41J 15/02; B41J 15/04; B41J 2/01

(57) ABSTRACT

A medium feeding apparatus includes a feeding roller which feeds a printing medium, a roll holding portion which holds a roll body around which the printing medium is wound, an intermediate roller which pulls out the printing medium from the roll body and feeds the printing medium to the feeding roller, and a controller which synchronizes and controls driving of the feeding roller and the intermediate roller, in which the controller sets a target value in a driving control of the intermediate roller to be greater than a target value in a driving control of the feeding roller, so that tension is not applied to the printing medium between the feeding roller and the intermediate roller, when the feeding roller and the intermediate roller feed the printing medium.

### BACKGROUND

1. Technical Field

The present invention relates to a medium feeding apparatus which feeds a medium such as a printing medium, and a control method of the medium feeding apparatus.

2. Related Art

Recently, as a printing apparatus, an apparatus is known, in which a feeding roller (a pair of transporting rollers) transporting a printing medium, a carriage driving mechanism in which a printing head is mounted performing printing on the printing medium transported by the feeding roller, and a roll driving mechanism in which a roll body is mounted rotating and driving the roll body, are provided (refer to JP-A-2009-242048).

However, in a configuration of the related art described above, since the feeding roller directly pulls out the printing medium from the roll body, eccentricity, inclination, or the like of the roll body affects transporting paper of the feeding roller, and as a result, there is a problem in that accuracy of transportation of paper by the feeding roller is deteriorated.

### SUMMARY

An advantage of some aspects of the invention is to provide a medium feeding apparatus which is capable of improving accuracy of transportation of paper by a feeding roller, and a control method of the medium feeding apparatus.

According to an aspect of the invention, there is provided a medium feeding apparatus includes a feeding roller that feeds a medium, a holding portion that holds a roll body around which the medium is wound, an intermediate roller that pulls out the medium from the roll body and feeds the medium to the feeding roller, and a driving control portion that synchronizes and controls driving of the feeding roller and the intermediate roller, in which the driving control portion sets a target value in a driving control of the intermediate roller to be greater than a target value in a driving control of the feeding roller, so that tension is not applied to the medium between the feeding roller and the intermediate roller, when the feeding roller and the intermediate roller feed the medium.

In this case, it is preferable that the driving control portion set a value, of which the target value in the driving control of the feeding roller is increased using the increase coefficient k, to be the target value in the driving control of the intermediate roller.

According to another aspect of the invention, there is provided a control method of a medium feeding apparatus including a feeding roller which feeds a medium, a holding portion which holds a roll body around which the medium is wound, and an intermediate roller which pulls out the medium from the roll body and feeds the medium to the feeding roller, the method includes controlling driving of the feeding roller and driving of the intermediate roller in a synchronizing manner, in which, in controlling, a target value in a driving control of the intermediate roller is set to be greater than a target value in a driving control of the feeding roller, so that tension is not applied to the medium between the feeding roller and the intermediate roller, when the feeding roller and the intermediate roller feed the medium.

According to this configuration, the intermediate roller is provided between the feeding roller and the roll body, and the target value in the driving control of the intermediate roller is set to be greater than that of the feeding roller, so that tension is not applied to the medium between the feeding roller and the intermediate roller (so as to be loosened), and thus the medium can be fed in a state in which the tension is not applied to the medium between the feeding roller and the intermediate roller. Accordingly, influence of eccentricity, inclination, or the like of the roll body on transportation of paper of the feeding roller can be avoid. Accordingly, accuracy of the transportation of paper by the feeding roller can be improved.

In the medium feeding apparatus, it is preferable that the driving control portion correct the increase coefficient k in accordance with a degree of deterioration of the intermediate roller, and set a value, of which the target value in the driving control of the feeding roller is increased using the corrected increase coefficient k, to be the target value in the driving control of the intermediate roller.

In this case, it is preferable that the driving control portion correct the increase coefficient k in accordance with a total feeding distance of the intermediate roller, and set a value, of which the target value in the driving control of the feeding roller is increased using the corrected increase coefficient k, to be a target value in the driving control of the intermediate roller.

According to the configuration, since the increase coefficient k of the target value is corrected in accordance with the degree of deterioration of the intermediate roller, even when the intermediate roller is deteriorated, a state in which the tension is not applied to the medium between the feeding roller and the intermediate roller can be maintained.

Meanwhile, it is preferable that the target value be a target position, and the driving control portion set a target position in the driving control of the intermediate roller to be greater than a target position of in the driving control of the feeding roller, so that tension is not applied to the medium between the feeding roller and the intermediate roller.

According to the configuration, when the feeding operation of the medium is finished, a state in which the tension is applied to the medium between the feeding roller and the intermediate roller can be avoid.

In this case, it is preferable that the target value be target speed, and the driving control portion set target speed in the driving control of the intermediate roller to be greater than target speed in the driving control of the feeding roller, so that tension is not applied to the medium between the feeding roller and the intermediate roller.

According to the configuration, since both of the target speed and the target position in the driving control of the intermediate roller are adjusted so that the tension is not applied to the medium between the feeding roller and the intermediate roller, even during the feeding operation as well as finishing the feeding operation, the state in which the tension is not applied to the medium between the feeding roller and the intermediate roller can be maintained.

### BRIEF DESCRIPTION OF THE DRAWINGS

The invention will be described with reference to the accompanying drawings, wherein like numbers reference like elements.

FIG. 1 is a plan view illustrating a schematic configuration of a printing apparatus according to an embodiment of the invention.

FIG. 2 is a side view illustrating a schematic configuration of the printing apparatus.

FIG. 3 is a block diagram illustrating a functional configuration of a controller.

FIG. 4 is a graph illustrating a relationship between arbitrary rotation speed of a roll body and a duty value necessary for rotating the roll body.

FIG. 5 is a block diagram illustrating a configuration of a feeding motor control portion and an intermediate motor control portion.

FIG. 6 is a table illustrating target speed and a target position being input to the feeding motor control portion and the intermediate motor control portion.

### DESCRIPTION OF EXEMPLARY EMBODIMENTS

Hereinafter, a medium feeding apparatus and a control method of the medium feeding apparatus according to an embodiment of the invention will be described with reference to attached drawings. In the embodiment, a printing apparatus for large-sized printing, to which the medium feeding apparatus and the control method of the medium feeding apparatus of the invention are applied, is exemplified. The printing apparatus performs printing with respect to the large-sized printing medium being fed by an ink jet manner while a large-sized printing medium (medium) is fed from the roll body. The roll body set in the printing apparatus is a roll body in which a long printing medium is wound around a cylindrical core in a roll shape. In addition, the printing medium is recording paper, films, cloths, or the like.

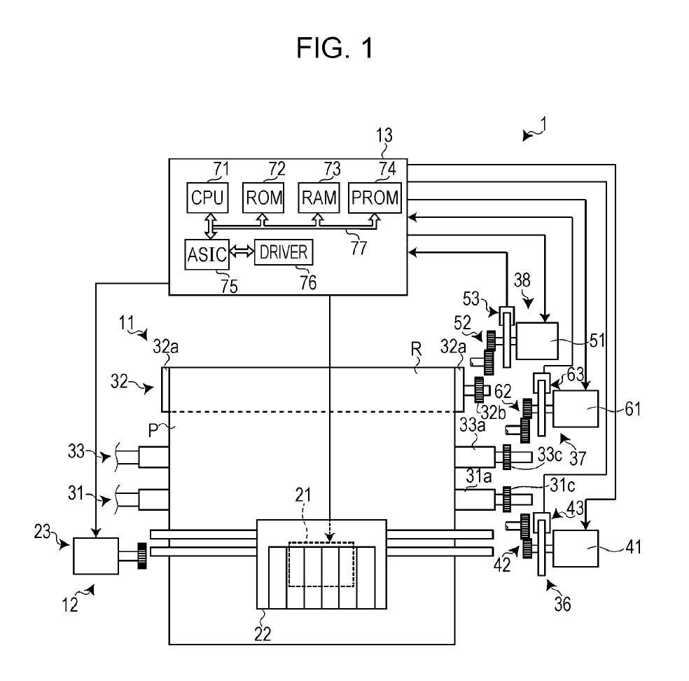

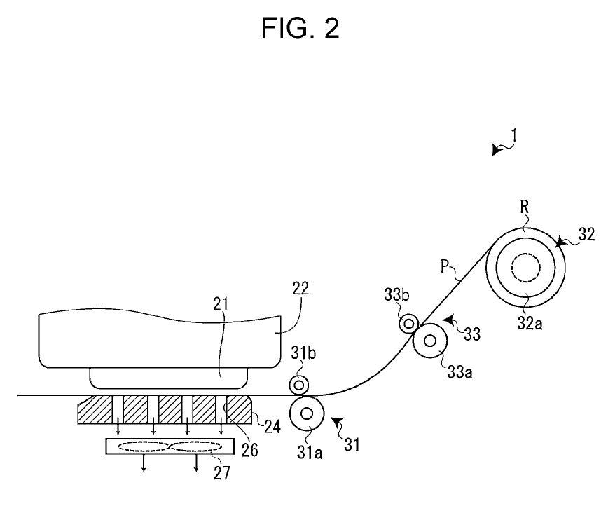

As illustrated in FIG. 1 and FIG. 2, the printing apparatus 1 is provided with a medium feeding mechanism 11 which feeds a printing medium P in a transporting paper direction, a printing mechanism 12 which performs printing on the printing medium P being fed by the medium feeding mechanism 11, and a controller 13 (driving control portion) which controls these mechanisms. The printing apparatus 1 performs printing on the printing medium P in a serial printing manner by repeating a line break feeding operation by the medium feeding mechanism 11 and a printing operation by the printing mechanism 12. Also, the “medium feeding apparatus” is configured with the medium feeding mechanism 11 and the controller 13.

The printing mechanism 12 performs printing on the printing medium P being fed by the feeding roller 31 to be described later, and is provided with a printing head 21 of an ink jet manner, a carriage 22 on which the printing head 21 is mounted, a reciprocating mechanism 23 which reciprocates the printing head 21 through the carriage 22, and a platen 24 against the printing head 21. Also, the printing mechanism 12 may be configured with a plurality of the printing heads 21, and may be configured with one printing head 21.

The printing head 21 includes a nozzle row (not illustrated) extending in the transporting paper direction of the printing medium P by the medium feeding mechanism 11, and discharges ink from a plurality of discharging nozzles of the nozzle row. Meanwhile, the reciprocating mechanism 23 reciprocates the printing head 21 in an intersecting direction with respect to the transporting paper direction. Also, the printing mechanism 12 performs the printing operation with respect to the printing medium P by driving the printing head 21 while the printing head 21 is moved forward and backward by the reciprocating mechanism 23.

Meanwhile, a plurality of suction holes 26 for vertically penetrating are formed in the platen 24. In addition, a suction fan 27 is provided under the platen 24. Also, when the suction fan 27 is operated, an inside of the suction hole 26 is negatively pressurized and the printing medium P on the platen 24 is sucked and held. In the embodiment, the printing operation with respect to the printing medium P is performed, in a state in which the printing medium P is sucked and held on the platen 24.

The medium feeding mechanism 11 is provided with the feeding roller 31 which performs transporting paper of the printing medium P, a roll holding portion 32 (holding portion) which holds the roll body R around which the printing medium P is wound, and an intermediate roller 33 which pulls out the printing medium P from the roll body R held by the roll holding portion 32, and feeds the medium to the feeding roller 31. In addition, the medium feeding mechanism 11 is provided with a feeding roller driving portion 36 which drives the feeding roller 31, an intermediate roller driving portion 37 which drives the intermediate roller 33, and a roll driving portion 38 which rotates and drives the roll body R.

The feeding roller 31 is configured with a nip roller configured with a driving roller 31a and a driven roller 31b. That is, the driving roller 31a and the driven roller 31b of the feeding roller 31 pinches the printing medium P therebetween and rotatably feeds the medium. In addition, the driving roller 31a includes a feeding input gear 31c receiving power from the feeding roller driving portion 36.

The feeding roller driving portion 36 is provided with a feeding motor 41 which is a power source, a feeding gear train 42 which transfers the power of the feeding motor 41 to the feeding roller 31, and a feeding rotation detecting portion 43 which detects a rotation position and a rotation direction of the feeding roller 31. The feeding motor 41 is, for example, a DC motor. In addition, the feeding gear train 42 is connected to the feeding input gear 31c provided in the driving roller 31a of the feeding roller 31. Also, when the power from the feeding motor 41 is transferred to the feeding input gear 31c through the feeding gear train 42, the driving roller 31a is rotated, and according to this, the driven roller 31b is rotated. As described above, the feeding roller 31 is rotatably driven by the power of the feeding motor 41.

The feeding rotation detecting portion 43 detects the rotation position and the rotation direction of the driving roller 31a of the feeding roller 31. Specifically, the feeding rotation detecting portion 43 is configured with a rotary encoder which is provided with a disc shaped scale and a photo interrupter provided in an output shaft of the feeding motor 41. That is, the feeding rotation detecting portion 43 detects the rotation position and the rotation direction of the driving roller 31 a of the feeding roller 31 by detecting the rotation position and the rotation direction of the output shaft of the feeding motor 41.

The roll holding portion 32 is provided with a pair of rotation holders 32a holding the roll body R, and a holder supporting portion (not illustrated) which freely rotates and supports each of the pair of the rotation holders 32a. The pair of rotation holders 32a is inserted into both ends of a core of the roll body R, and holds the roll body R from the both ends. In addition, one of the pair of rotation holders 32a includes a roll inputting gear 32b receiving the power from the roll driving portion 38.

The roll driving portion 38 is provided with a roll motor 51 which is power source, a roll gear train 52 which transfers the power of the roll motor 51 to the rotation holder 32, and a roll rotation detecting portion 53 which detects the rotation position and the rotation direction of the roll body R. The roll motor 51 is, for example, a DC motor. In addition, the roll gear train 52 is connected to the roll inputting gear 32b of the rotation holder 32a holding the roll body R. Also, when the power from the roll motor 51 is transferred to the roll inputting gear 32b through the roll gear train 52, the rotation holder 32a in which the roll inputting gear 32b is provided is rotated, and the roll body R which is held by the holder is rotated. Accordingly, the roll body R is rotated and driven by the power of the roll motor 51.

The roll rotation detecting portion 53 detects the rotation position and the rotation direction of the roll body R. Specifically, the roll rotation detecting portion 53 is configured with a rotary encoder including a disc shaped scale and the photo-interrupter provided in an output shaft of the roll motor 51. That is, the roll rotation detecting portion 53 detects the rotation position and the rotation direction of the roll body R by detecting the rotation position and the rotation direction of the output shaft of the roll motor 51.

The intermediate roller 33 is configured with a nip roller constituted by the driving roller 33a and the driven roller 33b. That is, the driving roller 33a and the driven roller 33b of the intermediate roller 33 pinches the printing medium P therebetween and rotates and transports the medium. In addition, the driving roller 33a includes an intermediate inputting gear 33c which receives the power from the intermediate roller driving portion 37.

The intermediate roller driving portion 37 is provided with an intermediate motor 61 which is power source, an intermediate gear train 62 which transfers the power of the intermediate motor 61 to the intermediate roller 33, and an intermediate rotation detecting portion 63 which detects the rotation position and the rotation direction of the intermediate roller 33. The intermediate motor 61 is, for example, a DC motor. In addition, the intermediate gear train 62 is connected to the intermediate inputting gear 33c provided in the driving roller 33a of the intermediate roller 33. Also, when the power from the intermediate motor 61 is transferred to the intermediate inputting gear through the intermediate gear train 62, the driving roller 33a is rotated, and the driven roller 33b is rotated in accordance with rotation of the driving roller. Accordingly, the intermediate roller 33 is rotated and driven by the power of the intermediate roller 61.

The intermediate rotation detecting portion 63 detects the rotation position and the rotation direction of the driving roller 33a of the intermediate roller 33. Specifically, the intermediate rotation detecting portion 63 is configured with a rotary encoder including a disc shaped scale and a photo-interrupter provided in the output shaft of the intermediate motor 61. That is, the intermediate rotation detecting portion 63 detects the rotation position and the rotation direction of the driving roller 33a of the intermediate roller 33 by detecting the rotation position and the rotation direction of the output shaft of the intermediate motor 61.

The controller 13 controls the printing apparatus 1 overall. Specifically, the controller 13 is provided with a central processing unit (CPU) 71, a read only memory (ROM) 72, a random access memory (RAM) 73, a programmable ROM (PROM) 74, an application specific integrated circuit (ASIC) 75, a motor driver 76, and a bus 77. In addition, in the controller 13, each pulse signal from the feeding rotation detecting portion 43, the roll rotation detecting portion 53, and the intermediate rotation detecting portion 63 is input.

In the printing apparatus 1 configured as described above, when receiving an execution instruction of printing job, printing operation (main scanning) by the printing mechanism 12 and line break feeding operation (sub scanning) in which the printing medium P is fed as a printing width of the printing mechanism 12 by the medium feeding mechanism 11 are alternately repeated, and thus a printing image is formed.

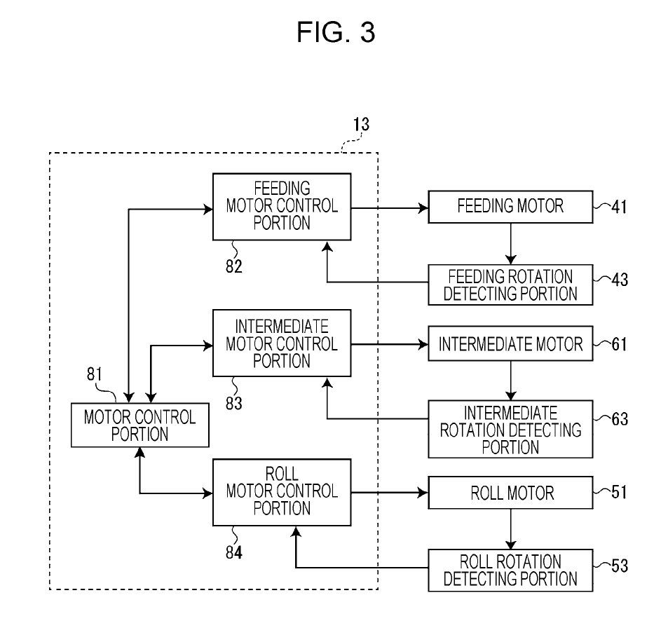

Next, with reference to FIG. 3, a functional configuration of the controller 13 will be described. As illustrated in FIG. 3, the controller 13 is provided with a main control portion 81, a feeding motor control portion 82, an intermediate motor control portion 83, and a roll motor control portion 84. Each of these functional portions is realized when a hardware constituting the controller 13 is cooperated with a software stored in a memory such as the ROM 72.

The main control portion 81 gives an instruction to the feeding motor control portion 82, the intermediate motor control portion 83, and the roll motor control portion 84. The main control portion 81 is capable of giving instructions to the feeding motor control portion 82, the intermediate motor control portion 83, and the roll motor control portion 84, so that the feeding motor 41, the intermediate motor 61, and the roll motor 51 are respectively and independently driven, and the feeding motor 41, the intermediate motor 61, and the roll motor 51 are driven to be synchronized.

The feeding motor control portion 82 drives and controls the feeding motor 41 by pulse width modulation (PWM) controlling through the motor driver 76. The feeding motor control portion 82 outputs a duty value which is PID-controlled to the motor driver 76, based on rotation speed or a rotation position of the driving roller 31a detected by the feeding rotation detecting portion 43.

The intermediate motor control portion 83 drives and controls the intermediate motor 61 by PWM-controlling through the motor driver 76. The intermediate motor control portion 83 outputs the PID-controlled duty value to the motor driver 76 based on the rotation speed or the rotation position of the driving roller 33a detected by the intermediate rotation detecting portion 63.

The roll motor control portion 84 drives and controls the roll motor 51 by PWM-controlling through the motor driver 76. The roll motor control portion 84 performs a calculation process for obtaining a motor output value and outputs the calculated motor output value to the motor driver 76.

In the calculation process, as Expression (1), basically, a motor output value Dx is obtained by subtracting Duty(f), which is a duty value (hereinafter, refer to as “tension control value”) necessary for applying a predetermined tension F to the printing medium P between the intermediate roller 33 and the roll body R, from a Duty(ro), which is a duty value necessary for rotating the roll body R at the rotation speed V.

$$Dx = Duty ( ro ) - Duty ( f ) = a \times V + b - \frac{\frac{F \times r}{M}}{Ts} \times Duty ( max ) \qquad ( 1 )$$

Here, r is a radius of the roll body R, M is a reduction ratio by the roll gear train 52, Duty(max) is a maximum value of the duty value, Ts is a starting torque of the roll motor 51, and a and b are coefficients calculated by measurement operation to be described later.

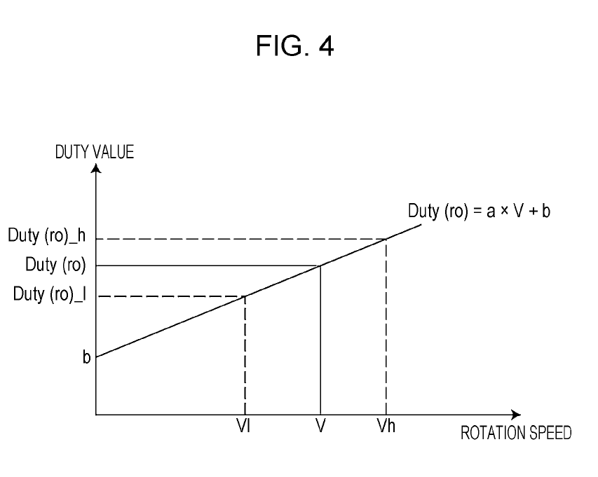

Here, refer to FIG. 4, the measurement operation will be described. As illustrated in FIG. 4, in the measurement operation, first, the controller 13 drives the roll motor 51 in a state in which the intermediate motor 61 is driven and stopped, so that the roll body R is rotated at rotation speed V1 of a low speed. Also, the controller 13 acquires the duty value output to the roll motor 51 as Duty(ro) _l at this time, when the rotation speed of the roll body R is stabled at the rotation speed V1. Next, the controller 13 drives the roll motor 51 so as to rotate the roll body R at a rotation speed Vh of high speed, in a state in which driving of the intermediate motor 61 is stopped. The controller 13 acquires the duty value Duty(ro) _h corresponding to the rotation speed Vh of high speed in the same manner as at the time of acquiring the duty value Duty(ro) _l corresponding to the rotation speed V1 of low speed.

Simultaneous equation relating to the coefficients a and b can be obtained by substituting these values into Expression (2).

Duty(ro)=a×V+b (2)

When the simultaneous equation is solved, the coefficients a and b are determined and are reflected in Expression (1).

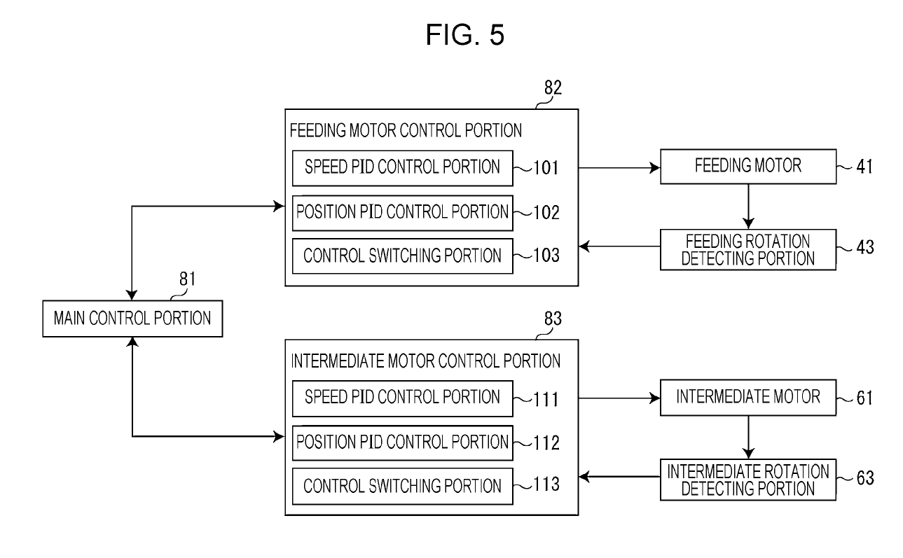

Next, with reference to FIG. 5, configurations of the feeding motor control portion 82 and the intermediate motor control portion 83 will be described. As illustrated in FIG. 5, the feeding motor control portion 82 is provided with a speed PID control portion 101, a position PID control portion 102, and a control switching portion 103.

The speed PID control portion 101 PID-controls the feeding motor 41 (speed PID controlling) so that the rotation speed of the driving roller 31a becomes target speed (target rotation speed) input from the main control portion 81. Specifically, the speed PID control portion 101 calculates, first, a speed error ΔV between current rotation speed detected by the feeding rotation detecting portion 43 and target speed input from the main control portion 81. Also, based on the calculated speed error ΔV, each control value Q is calculated by Expressions (3) to (5) as follows.

QP(j)=ΔV(j)×Kp (3)

QI(j)=(j−1)+ΔV(j)×Ki (4)

QD(j)={ΔV(j)−ΔV(j−1)}×Kd (5)

Here, j is time, Kp is a proportional gain, Ki is an integral gain, and Kd is a differential gain.

If each control value is calculated, each of the calculated control values is summed up, and a PWM signal of the duty value in accordance with a total control value Qpid is output to the motor driver 76. The motor driver 76 drives the feeding motor 41 by PWM-controlling based on the PWM signal.

The position PID control portion 102 PID-controls the feeding motor 41 (position PID controlling), so that the rotation position of the driving roller 31a becomes target position (target rotation amount) input from the main control portion 81. Specifically, first, the position PID control portion 102 calculates a rotation position of the current feeding roller 31 detected by the feeding rotation detecting portion 43 and a position error of the target position instructed from the main control portion 81. Next, when the calculated position error is multiplied by a predetermined position gain, and is subtracted the current rotation speed detected by the feeding rotation detecting portion 43 from the error, a deviation ΔH is calculated. Also, based on the calculated deviation ΔH, each control value Q is calculated by Expressions (6) to (8).

QP(j)=ΔH(j)×Kp (6)

QI(j)=ΔQI(j−1)+ΔH(j)×Ki (7)

QD(j)={ΔH(j)−ΔH(j−1)}×Kd (8)

If each control value is calculated, the calculated control values are summed up, and the PWM signal of the duty value in accordance with the total control value Qpid is output to the motor driver 76. The motor driver 76 PWM-controls and drives the feeding motor 41 based on the PWM signal.

The control switching portion 103 receives instructions from the main control portion 81, and regarding controlling of the feeding motor 41, switches speed PID controlling by the speed PID control portion 101 and position PID controlling by the position PID control portion 102.

The intermediate motor control portion 83 is provided with a speed PID control portion 111, a position PID control portion 112, and a control switching portion 113 in the same manner as that of the feeding motor control portion 82.

The speed PID control portion 111 PID-controls the intermediate motor 61 (speed PID controlling) so that the rotation speed of the driving roller 33 a becomes the target speed (target rotation speed) input from the main control portion 81. Specifically, first, the speed PID control portion 111 calculates the current rotation speed detected by the intermediate rotation detecting portion 63, and the speed error ΔV of the target speed instructed from the main control portion 81. Also, based on the calculated speed error ΔV, by Expressions (3) to (5) as described above, each control value Q is calculated.

When each control value is calculated, the calculated control values are summed up, the PWM signal of the duty value in accordance with the total control value Qpid is output to the motor driver 76. The motor driver 76 drives the intermediate motor 61 by PWM-controlling based on the PWM signal.

The position PID control portion 112 PID-controls the intermediate motor 61 (position PID controlling) so that the rotation position of the driving roller 33a becomes the target position (target rotation amount) input from the main control portion 81. Specifically, first, the position PID control portion 112 calculates a position error between the current rotation position of the intermediate roller 33 detected by the intermediate rotation detecting portion 63 and the target position instructed from the main control portion 81. Next, when a predetermined position gain is multiplied to the calculated position error, and is subtracted the current rotation speed detected by the intermediate rotation detecting portion 63, a deviation ΔH is calculated. Also, each control value Q is calculated by Expressions (6) to (8) based on the calculated deviation ΔH.

If each control value is calculated, the calculated control values are summed up, the PWM signal of the duty value in accordance with the total control value Qpid is output to the motor driver 76. The motor driver 76 drives the intermediate motor 61 by PWM-controlling based on the PWM signal.

When the control switching portion 113 receives instructions from the main control portion 81, and regarding controlling of the intermediate motor 61, switches the speed PID controlling by the speed PID control portion 111 and the position PID controlling by the position PID control portion 112.

Next, controlling of the feeding motor 41 and the intermediate motor 61 in the line break feeding operation will be described. In the line break feeding operation, the main control portion 81 switches the speed PID controlling and the position PID controlling in motor control portions 82 and 83, inputs the target speed and the target position, controls the feeding motor 41 and the intermediate motor 61. In the embodiment, in the line break feeding operation, which is constituted by an acceleration section, a constant velocity section, and a deceleration section, and the controlling is switched to the speed PID controlling until the middle of the deceleration section, and after that, is switched to the position PID controlling. In addition, at the time of switching to the speed PID controlling, the target speed is input, and at the time of switching to the position PID controlling, the target position is input.

The main control portion 81 synchronizes switching between the speed PID controlling and the position PID controlling in the intermediate motor control portion 83 with the feeding motor control portion 82, synchronizes inputting of the target speed and the target position with respect to the intermediate motor control portion 83 with the feeding motor control portion 82. Accordingly, during the line break feeding operation, the feeding motor 41 and the intermediate motor 61 are synchronized and controlled, driving of the feeding roller 31 and the intermediate roller 33 are synchronized and controlled (driving control step).

At this time, in the embodiment, the target speed and the target position being input to the intermediate motor control portion 83 are increased more than the target speed and the target position being input to the feeding motor control portion 82, so that tension is not applied to the printing medium P between the feeding roller 31 and the intermediate roller 33. That is, in the line break feeding operation, when the feeding roller 31 and the intermediate roller 33 feed the printing medium P, since a feeding amount of the feeding roller 31 is increased more than a feeding amount of the intermediate roller 33, by slipping with respect to the printing medium P of the intermediate roller 33, the main control portion 81 sets the target speed and the target position being input to the intermediate motor control portion 83 to be increased more than the target speed and the target position being input to the feeding motor control portion 82, so that tension is not applied to the printing medium P between the feeding roller 31 and the intermediate roller 33. Specifically, a value, of which the target speed and the target position being input to the feeding motor control portion 82 are increased using an increase coefficient k, is set to target speed and a target position being input to the intermediate motor control portion 83.

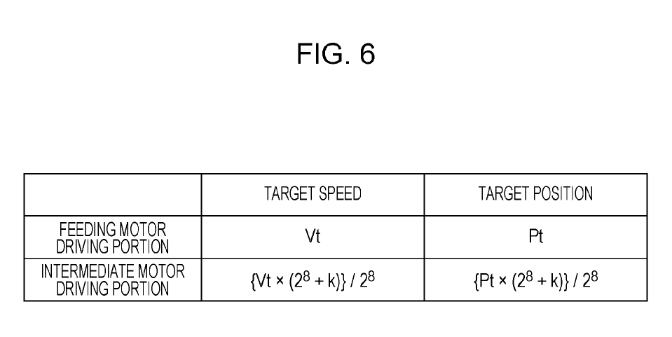

More specifically, as illustrated in FIG. 6, a value obtained by substituting target speed Vt being input to the feeding motor control portion 82 to Expression (9) as follow is set to target speed being input to the intermediate motor control portion 83.

{Vt×(2⁸+k)}/2⁸ (9)

In addition, a value obtained by substituting a target position Pt being input to the feeding motor control portion 82 to Expression (10) as follow is set to a target position being input to the intermediate motor control portion 83.

{Pt×(2⁸+k)}/2⁸ (10)

Accordingly, in the line break feeding operation, a state in which tension is not applied to the printing medium P between the feeding roller 31 and the intermediate roller 33 is maintained, that is, a state in which the printing medium P between the feeding roller 31 and the intermediate roller 33 is loosened as a certain amount is maintained. In this state, the printing medium P can be fed by the feeding roller 31 and the intermediate roller 33. Also, in the embodiment, in a state before the line break feeding operation, the tension is applied to the printing medium P between the intermediate roller 33 and the roll body R, the tension is not applied to the printing medium P between the feeding roller 31 and the intermediate roller 33, and the printing medium P is transported while maintaining these states. That is, by Expressions (9) and (10), when the target speed and the target position being input to the intermediate motor control portion 83 are set so that a feeding amount of the feeding roller 31 is always equal to a feeding amount of the intermediate roller 33, and the printing medium P is fed while maintaining the state.

In addition, the increase coefficient k as described above is corrected in accordance with a degree of deterioration of the intermediate roller 33 in every the line break feeding operation. Specifically, since the degree of deterioration of the intermediate roller 33 correlates with a total feeding distance (total count value counted by the intermediate rotation detecting portion 63 in the entire line break feeding operation) (total feeding rotation amount) of the printing medium P in the intermediate roller 33, the main control portion 81 corrects the increase coefficient k in every the line break feeding operation, in accordance with the total feeding distance of the intermediate roller 33.

More specifically, first, a correction coefficient m (unit is “%”) is calculated by Expression (11) as follow using the total feeding distance Cs.

m={1−1/(Cs/c+1)}/d (11)

Here, c and d are a predetermined coefficient.

Also, a value obtained by substituting the calculated correction coefficient m and the increase coefficient k to Expression (12) is set to the corrected increase coefficient k.

k(k×m)/100 (12)

The main control portion 81 corrects such an increase coefficient k in every the line break feeding operation. A value of which the target speed and the target position being input to the feeding motor control portion 82 is increased using the corrected increase coefficient k is set to target speed and a target position being input to the intermediate motor control portion 83. Accordingly, even when the intermediate roller 33 is deteriorated, the feeding amount of the feeding roller 31 and the feeding amount of the intermediate roller 33 are always equal to each other.

Hitherto, according to the embodiment, the target value (target speed and target position) in a driving control of the intermediate roller 33 is increased more than the feeding roller 31, so that the intermediate roller 33 between the feeding roller 31 and the roll body R is provided, and the tension is not applied to the printing medium P between the feeding roller 31 and the intermediate roller 33 (so as to be loosened). Accordingly, since influence of eccentricity, inclination, or the like of the roll body R is blocked by the intermediate roller 33, the eccentricity, inclination, or the like of the roll body R can be avoid to be affected to transportation of paper of the feeding roller 31. Therefore, accuracy of the transportation of paper by the feeding roller 31 can be improved.

In addition, since the increase coefficient k of the target value is corrected in accordance with the intermediate roller 33, even when the intermediate roller 33 is deteriorated, a state in which tension is not applied to a medium between the feeding roller 31 and the intermediate roller 33 can be maintained.

Further, as a target value in a driving control of the intermediate roller 33, since both of the target speed and the target position are adjusted, the state in which tension is not applied to the medium between the feeding roller 31 and the intermediate roller 33 can be strictly maintained.

Also, in the embodiment described above, when setting the target position and the target speed being input to the intermediate motor control portion 83 are set, so that the feeding amount of the printing medium P by the feeding roller 31 and the feeding amount of the printing medium P by the intermediate roller 33 are equal to each other, before the line break feeding operation, the state of the printing medium P between the feeding roller 31 and the intermediate roller 33 (loosened state as a certain amount without applying tension) is maintained, but it is preferable that the target position and the target speed being input to the intermediate motor control portion 82 be set, so that the feeding amount of the printing medium P by the intermediate roller 33 is increased more than the feeding amount of the printing medium P by the feeding roller 31. According to this configuration, in a state before the line break feeding operation, even when the tension is applied to the printing medium P between the feeding roller 31 and the intermediate roller 33, the tension is relaxed, and a state in which the tension is not applied thereto can be maintained.

Also, in the embodiment described above, it is configured that both of the target speed and the target position in the driving control of the intermediate roller 33 are set to values of which values (target speed and target position) in the driving control of the feeding roller 31 is increased using the increase coefficient k, but only the target speed may be set to the value of which the value (target speed) in the driving control of the feeding roller 31 is increased using the increase coefficient k, or may be only the target position be set to a value of which the value (target position) in the driving control of the feeding roller 31 is increased using the increase coefficient k.

Also, in the embodiment described above, it is configured that a total count value of the intermediate rotation detecting portion 63 in the entire line break feeding operation is set to a total feeding distance of the intermediate roller 33, and the increase coefficient k is corrected, but a total count value including the count value counted by the intermediate rotation detecting portion 63 at the time of feeding the printing medium P (for example, transporting paper in manual operation) other than the line break feeding operation may be set to the total feeding distance of the intermediate roller 33, and the increase coefficient k may be corrected.

In addition, in the embodiment described above, the increase coefficient k is corrected in accordance with the total feeding distance of the intermediate roller 33, but if the increase coefficient k is corrected in accordance with the degree of deterioration of the intermediate roller 33, it is not limited thereto. For example, the increase coefficient k may also be corrected in accordance with a use time of the intermediate roller 33, and the like.

This application claims priority under 35 U.S.C. §119 to Japanese Patent Application No. 2016-059150, filed Mar. 23 2016. The entire disclosure of Japanese Patent Application No. 2016-059150 is hereby incorporated herein by reference.

What is claimed is:

1. A medium feeding apparatus comprising:
a feeding roller that feeds a medium;
a holding portion that holds a roll body around which the medium is wound;
an intermediate roller that pulls out the medium from the roll body and feeds the medium to the feeding roller; and
a driving control portion that synchronizes and controls driving of the feeding roller and the intermediate roller,
wherein the driving control portion sets a target value in a driving control of the intermediate roller to be greater than a target value in a driving control of the feeding roller, so that tension is not applied to the medium between the feeding roller and the intermediate roller, when the feeding roller and the intermediate roller feed the medium.

2. The medium feeding apparatus according to claim 1,
wherein the driving control portion sets a value, of which the target value in the driving control of the feeding roller is increased using an increase coefficient k, to be the target value in the driving control of the intermediate roller.

3. The medium feeding apparatus according to claim 2,
wherein the driving control portion corrects the increase coefficient k in accordance with a degree of deterioration of the intermediate roller, and sets a value, of which the target value in the driving control of the feeding roller is increased using the corrected increase coefficient k, to be the target value in the driving control of the intermediate roller.

4. The medium feeding apparatus according to claim 3,
wherein the driving control portion corrects the increase coefficient k in accordance with a total feeding distance of the intermediate roller, and sets a value, of which the target value in the driving control of the feeding roller is increased using the corrected increase coefficient k, to be a target value in the driving control of the intermediate roller.

5. The medium feeding apparatus according to claim 1,
wherein the target value is a target position, and
wherein the driving control portion sets a target position in the driving control of the intermediate roller to be greater than a target position of in the driving control of the feeding roller, so that tension is not applied to the medium between the feeding roller and the intermediate roller.

6. The medium feeding apparatus according to claim 5,
wherein the target value is target speed, and
wherein the driving control portion sets target speed in the driving control of the intermediate roller to be greater than target speed in the driving control of the feeding roller, so that tension is not applied to the medium between the feeding roller and the intermediate roller.

7. A control method of a medium feeding apparatus which includes a feeding roller that feeds a medium, a holding portion that holds a roll body around which the medium is wound, and an intermediate roller that pulls out the medium from the roll body and feeds the medium to the feeding roller, the method comprising:
controlling driving of the feeding roller and driving of the intermediate roller in a synchronizing manner,
wherein, in the controlling, a target value in a driving control of the intermediate roller is set to be greater than a target value in a driving control of the feeding roller, so that tension is not applied to the medium between the feeding roller and the intermediate roller, when the feeding roller and the intermediate roller feed the medium.
